(19) United States
(12) Patent Application Publication
(10) Pub. No.: US 2026/0219132 A1
(43) Pub. Date: Jul. 30, 2026

(54) MODULATION TRANSFER FUNCTION MEASUREMENT APPARATUS AND METHOD FOR OPTICAL DEVICES

(71) Applicant: Applied Materials, Inc., Santa Clara, CA (US)

(72) Inventors: Jinxin FU, Fremont, CA (US); Yangyang SUN, San Jose, CA (US); Chi-Yuan YANG, Santa Clara, CA (US); Ludovic GODET, Sunnyvale, CA (US)

(21) Appl. No.: 19/150,182

(22) PCT Filed: Feb. 5, 2024
(86) PCT No.: PCT/US2024/014477

§ 371 Date: Jul. 22, 2025

Related U.S. Application Data
(60) Provisional application No. 63/443,926, filed on Feb. 7, 2023.

(51) Int. Cl. G01M 11/02

(52) U.S. Cl. CPC G01M 11/0292

(57) ABSTRACT

Embodiments herein provide for a measurement system for determining an optical device modulation transfer function (MTF). The measurement system includes a stage operable to retain an optical device or an optical device substrate having at least one optical device disposed thereon. A light engine is disposed above the stage. The light engine includes a light source operable to project a light to the optical device at a range of wavelengths. A reticle is operable to form a pattern from the light projected from the light source. A first lens operable to collimate the light from the light source toward the optical device or optical device substrate. A near field detector is operable to detect the light from the optical device or optical device substrate. A far field detector is operable to detect the light from the optical device of optical device substrate.

### BACKGROUND

### Field

Embodiments of the present disclosure generally relate to optical devices. More specifically, embodiments described herein provide for a method and apparatus for determining a modulation transfer function (MTF) of an optical device.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment. Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is determining the optical resolution of the optical devices to ensure that image quality standards are met. Current measurement systems for optical devices generally have low sampling rates across a large field of view as well as low throughput and fail to properly compensate for imperfections in image quality caused by cameras and image projectors within the measurement systems. Additionally, the measurement systems may be bulky and are susceptible to imperfections associated with the image projectors of the measurement system. Therefore, it is desirable to have a system and method for optical resolution measurement that will not be affected by imperfections associated with the image projector or camera and will have an improved throughput. Accordingly, what is needed in the art is a method of determining a MTF of an optical device.

### SUMMARY

In one embodiment, a measurement system is provided. The measurement system includes a stage operable to retain an optical device or an optical device substrate having at least one optical device disposed thereon, a light engine, a near field detector, and a far field detector. The light engine is disposed above the stage and includes a light source, a reticle operable to form a pattern from the light projected from the light source, and a first lens operable to collimate the light from the light source toward the optical device or optical device substrate. The light source is operable to project a light to the optical device at a range of wavelengths. The first lens is operable to collimate the light from the light source toward the optical device or optical device substrate. The near field detector operable to detect the light from the optical device or optical device substrate. The far field detector operable to detect the light from the optical device of optical device substrate.

In another embodiment, a method is disclosed. The method includes projecting an image of a pattern, the image projected from a light engine of a measurement system, capturing a near field image at the near field detector, capturing a far field image at the far field detector, analyzing the near field image and far field image to locate a first plurality of points on the near field image and far field image, the first plurality of points converted into a near field function and far field function, obtaining a near field fast Fourier transform (FFT) of the near field function and far field FFT of the far field function, and determining an optical device modulation transfer function (MTF) of the one or more optical devices, the optical device MTF determined by comparing the near field FFT to the far field FFT corresponding to the image. The measurement system includes a stage disposed under the light engine, the stage operable to have one or more optical devices disposed thereon. The light engine is disposed above the stage projects the baseline image to the one or more optical devices. The near field detector is operable to detect the light from the optical device. The far field detector operable to detect the light from the optical device.

In yet another embodiment, a controller of a measurement system is disclosed. The controller stores instructions that, when executed by a processor, causes the measurements system to measure optical properties of an optical device of optical device substrate disposed in a measurement system. The optical properties of the optical device or optical device substrate include projecting a baseline image of a pattern. The baseline image is projected from a light engine of a measurement system. A near field image is captured at a near field detector of the measurement system. A far field image is captured at a far field detector of the measurement system. The near field image and far field image are analyzed to locate a first plurality of points on the near field image and far field image. The first plurality of points are converted into a near field function and far field function. A near field fast Fourier transform (FFT) of the near field function and far field FFT of the far field function are obtained. An optical device modulation transfer function (MTF) of the one or more optical devices is determined. The optical device MTF is determined by comparing the near field FFT to the far field FFT corresponding to the baseline image.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a perspective, frontal view of a substrate according to embodiments described herein.

FIG. 1B is a perspective, frontal view of an optical device according to embodiments described herein.

FIG. 2 is a schematic, cross-sectional view of the measurement system according to embodiments described herein.

FIG. 3A-3E are schematic illustrations of a measurement system for determining a modulation transfer function (MTF) of an optical device according to embodiments described herein.

FIG. 4 is a flow diagram of a method for determining a modulation transfer function (MTF) of an optical device according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices. More specifically, embodiments described herein provide for a method of determining a modulation transfer function (MTF) of an optical device.

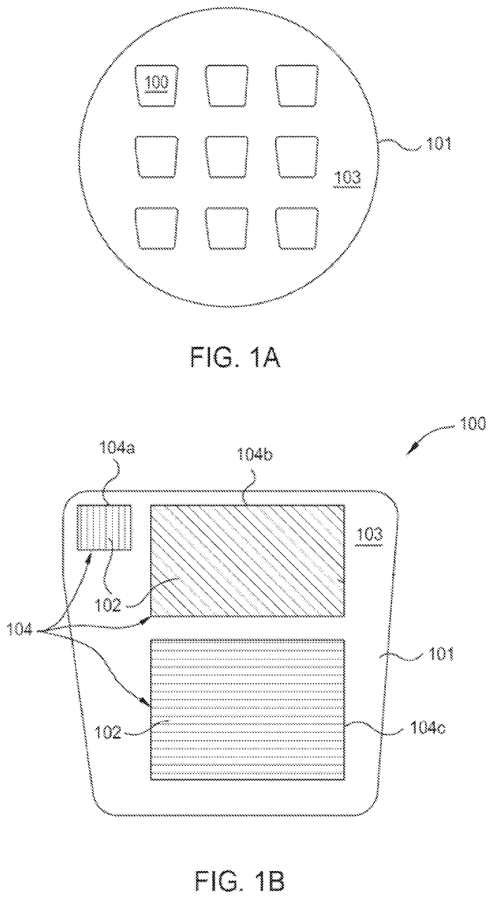

FIG. 1A is a perspective, frontal view of a substrate 101 according to embodiments described herein. The substrate 101 includes a plurality of optical devices 100 disposed on a surface 103 of the substrate 101. The optical devices 100 are waveguide combiners utilized for virtual, augmented, or mixed reality. In some embodiments, which can be combined with other embodiments described herein, the optical devices 100 are flat optical devices, such as metasurfaces.

The substrate 101 can be any substrate used in the art, and can be either opaque or transparent to a chosen laser wavelength depending on the use of the substrate 101. Additionally, the substrate 101 may be of varying shapes, thicknesses, and diameters. For example, the substrate 101 may have a diameter of about 150 mm to about 300 mm. The substrate 101 may have a circular, rectangular, or square shape. The substrate 101 may have a thickness of between about 300 μm to about 1 mm. Although only nine optical devices 100 are shown on the substrate 101, any number of optical devices 100 may be disposed on the surface 103.

FIG. 1B is a perspective, frontal view of an optical device 100. It is to be understood that the optical devices 100 described herein are exemplary optical devices and the other optical devices may be used with or modified to accomplish aspects of the present disclosure. The optical device 100 includes a plurality of optical device structures 102 disposed on a surface 103 of a substrate 101. The optical device structures 102 may be nanostructures having sub-micron dimensions, e.g., nano-sized dimensions. Regions of the optical device structures 102 correspond to one or more gratings 104, such as a first grating 104a, a second grating 104b, and a third grating 104c. In some embodiments, which can be combined with other embodiments described herein, the optical device 100 includes at least the first grating 104a corresponding to an input coupling grating and the third grating 104c corresponding to an output coupling grating. In some embodiments, which can be combined with other embodiments described herein, the optical device 100 also includes the second grating 104b corresponding to an intermediate grating. The optical device structures 102 may be angled or binary. The optical device structures 102 may have other shapes including, but not limited to, circular, triangular, elliptical, regular polygonal, irregular polygonal, and/or irregular shaped cross-sections.

In operation, the first grating 104a receives incident beams of light (a virtual image) having an intensity from a light source. The incident beams are split by the optical device structures 102 into T1 beams that have all of the intensity of the incident beams in order to direct the virtual image to the intermediate grating (if utilized) or the third grating 104c. In some embodiments, which can be combined with other embodiments described herein, the T1 beams undergo total-internal-reflection (TIR) through the optical device 100 until the T1 beams come in contact with the optical device structures 102 of the intermediate grating. The optical device structures 102 of the intermediate grating diffract the T1 beams to T−1 beams that undergo TIR through the optical device 100 to the optical device structures 102 of the third grating 104c. The optical device structures 102 of the third grating 104c outcouple the T−1 beams to the user's eye to modulate the field of view of the virtual image produced from the light source from the user's perspective and further increase the viewing angle from which the user can view the virtual image. In some embodiments, which can be combined with other embodiments described herein, the T1 beams undergo TIR through the optical device 100 until the T1 beams come in contact with the optical device structures 102 of the third grating 104c and are outcoupled to modulate the field of view of the virtual image produced from the light source.

To ensure that the optical devices 100 meet image quality standards, the optical device MTF of the optical devices 100 is obtained. In some embodiments, the optical device MTF provides image quality information related to image resolution and image contrast. Embodiments of the measurement system 200 described herein provide for the ability to obtain the optical device MTF with increased throughput and greater quality control. Additionally, embodiments of the measurement system 200 described herein provide for the ability to obtain the optical device MTF such that the measured optical device MTF is not strongly influenced by the imperfections of an image projector and/or a camera, such as distortion and astigmatism. Embodiments described herein allow for image quality separation between the optical device 100 and the measurement system 200, which may include imperfections attributable solely to a camera or projector. The MTF is a metric utilized to determine the ability of the optical devices 100 to transfer contrast at a particular resolution from an object to an image.

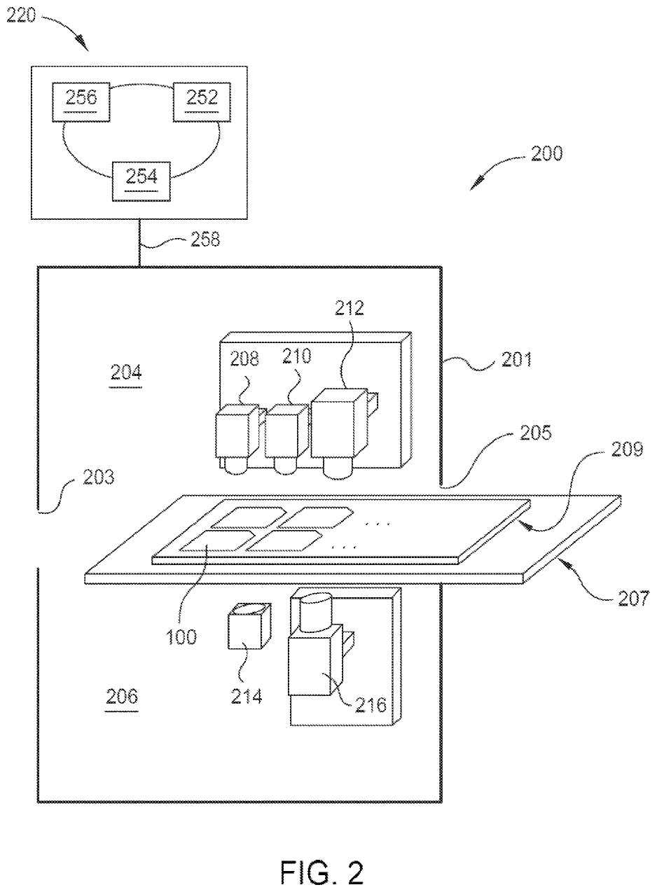

FIG. 2 is a schematic, cross-sectional view of the measurement system 200 according to embodiments described herein. The measurement system 200 includes a body 201 with a first opening 203 and a second opening 205 to allow a stage 207 to move therethrough. The stage 207 is operable to move in an X-direction, a Y-direction, and a Z-direction in the body 201 of the measurement system 200. The stage 207 includes a tray 209 operable to retain the optical devices 100 (as shown herein) or one or more substrates 101.

The measurement system 200 is operable to project images such that the MTF of the optical device 100 can be determined. The stage 207 and the tray 209 may be transparent such that the MTF obtained utilizing the measurement system 200 is not impacted by the translucence of the stage 207 or the tray 209. The measurement system 200 is in communication with a controller 220 operable to control operation of measurement system 200 and the method 400 described herein.

The measurement system 200 includes an upper portion 204 oriented toward a top side of the optical devices 100 and a lower portion 206 oriented toward a bottom side of the optical devices 100. The upper portion 204 of the measurement system 200 includes an alignment camera 208, a light engine 210, and a reflection detector 212. The reflection detector 212 detects outcoupled beams projected from the third grating 104c from the top side of the optical devices 100. The reflection detector 212 includes a near field detector, a far field detector, a wave sensor, or combinations thereof. The reflection detector 212 of the measurement system 200a and measurement system 200c include a near field detector 320. The near field detector 320 is operable to capture an image of the outcoupled beams at the pupil plane of the third grating 104c in measurement system 200a. By capturing the image of the outcoupled beams at the pupil plane of third grating 104c, the measurement system 200a can image the outcoupled beams within the third grating 104c. The reflection detector 212 of the measurement system 200c further includes a lens 322 to focus the outcoupled beams toward the near field detector 320 when the near field detector 320 is not in the pupil plane. The reflection detector 212 of measurement system 200b and 200e includes a far field detector 310. The far field detector 310 is operable to capture an image of the outcoupled beams at a position of a display on which the image would be projected. The reflection detector 212 of the measurement system 200d includes a wavefront sensor 325. The wavefront sensor 325 is operable to capture an image of the outcoupled beams at the pupil plane of the third grating 104c in measurement system 200d. By capturing the image of the outcoupled beams at the pupil plane of third grating 104c, the measurement system 200d can image the outcoupled beams before the outcoupled beams experience distortion and dispersion as they propagate toward a display.

The transmission detector 216 detects outcoupled beams projected from the third grating 104c through the bottom side of the optical devices 100. The transmission detector 216 includes a near field detector, a far field detector, a wavefront sensor, or combinations thereof. The transmission detector 216 of the measurement system 200a and measurement system 200c include a far field detector 310. The far field detector 310 is operable to capture an image of the outcoupled beams at a position of a display on which the image would be projected. The transmission detector 216 of measurement system 200b includes a near field detector 320. The near field detector 320 is operable to capture an image of the outcoupled beams at the pupil plane of the third grating 104c in measurement system 200b. By capturing the image of the outcoupled beams at the pupil plane of third grating 104c, the measurement system 200b can image the outcoupled beams before the outcoupled beams experience distortion and dispersion as they propagate toward a display. The transmission detector 216 of the measurement system 200e includes a wavefront sensor 325. The wavefront sensor 325 is operable to capture an image of the outcoupled beams at the pupil plane of the third grating 104c in measurement system 200e. By capturing the image of the outcoupled beams at the pupil plane of third grating 104c, the measurement system 200e can image the outcoupled beams before the outcoupled beams experience distortion and dispersion as they propagate toward a display.

The alignment camera 208 is operable to determine a position of the stage 207 and the optical devices 100. The light engine 210 is operable to illuminate the first grating 104a. In some embodiments, which can be combined with other embodiments described herein, the light engine 210 projects an image of a pattern to the first grating 104a.

The lower portion 206 of the first subsystem 202 includes a code reader 214 and a transmission detector 216. The code reader 214 is operable to read a code of the optical devices, such as a quick response (QR) code or barcode of an optical device 100. The code read by the code reader 214 may include instructions for obtaining the optical device MTF for various optical devices 100.

The controller 220 is coupled to the measurement system 200. The controller 220 includes a processor 252, a memory 254, and support circuits 256 that are coupled to one another. The controller 220 is electrically coupled to the measurement system 200 via a wire 258. The wire 258 may also represent, in some embodiments, a wireless connection. The processor 252 may be one of any form of general purpose microprocessor, or a general purpose central processing unit (CPU), each of which can be used in an industrial setting, such as a programmable logic controller (PLC), supervisory control and data acquisition (SCADA) systems, general purpose graphics processing unit (GPU), or other suitable industrial controller. The memory 254 is non-transitory and may be one or more of readily available memory such as random access memory (RAM), read only memory (ROM), or any other form of digital storage, local or remote. The memory 254 contains instructions, that when executed by the processor 252, facilitates execution of the method 400. The instructions in the memory 254 are in the form of a program product such as a program that implements the method of the present disclosure. The program code of the program product may conform to any one of a number of different programming languages. Illustrative computer-readable storage media include, but are not limited to: (i) non-writable storage media (e.g., read-only memory devices within a computer such as CD-ROM disks readable by a CD-ROM drive, flash memory, ROM chips, or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are examples of the present disclosure.

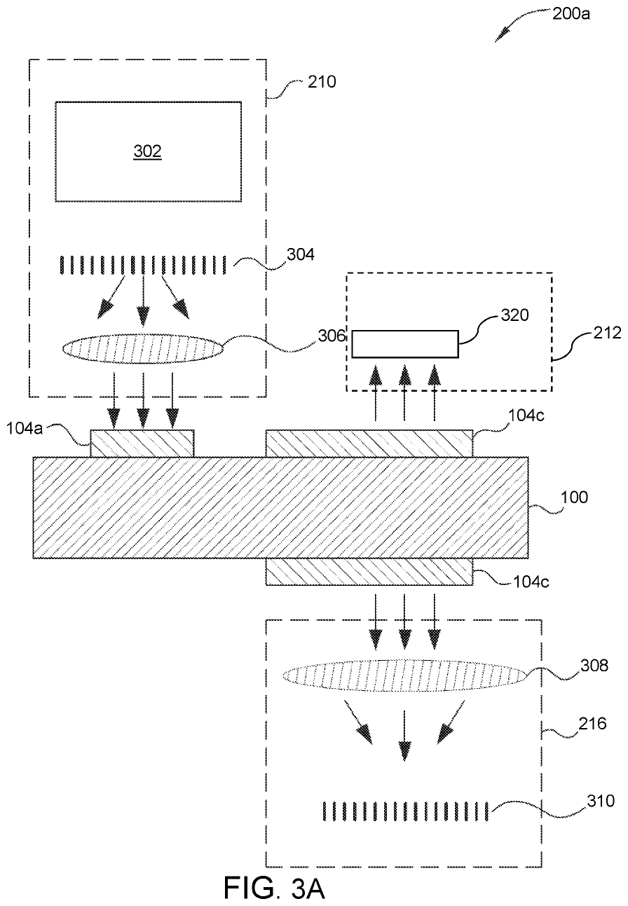

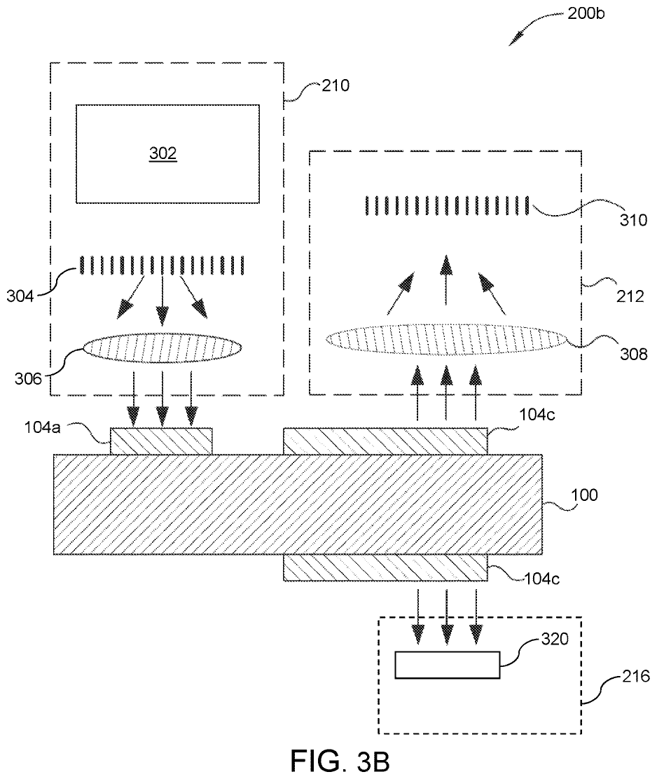

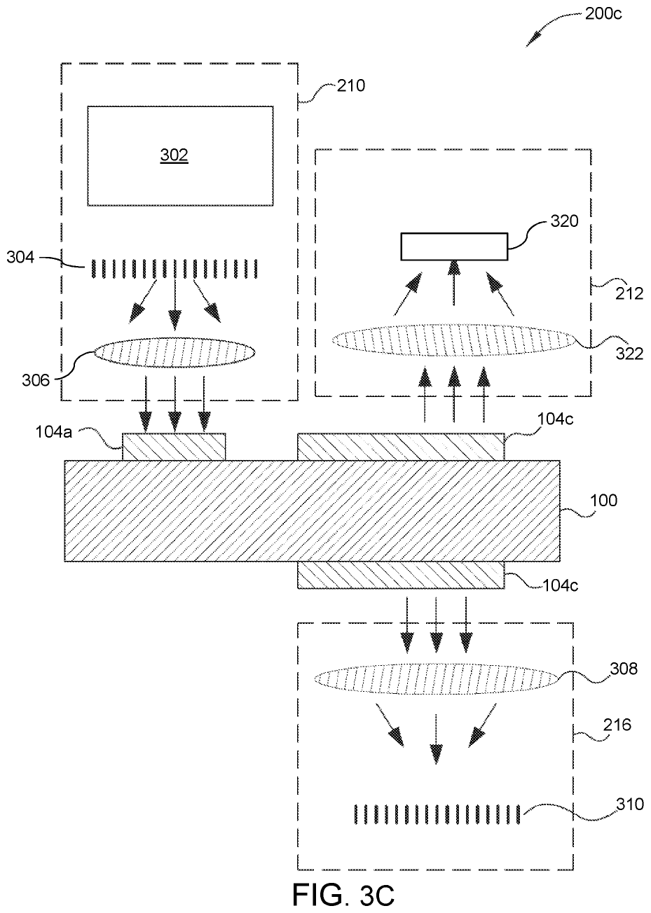

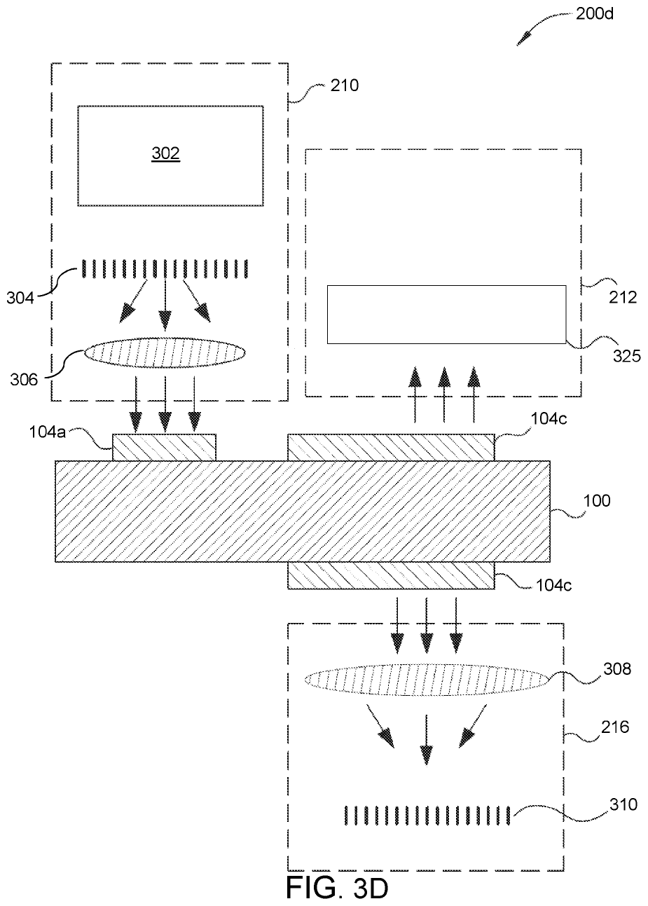

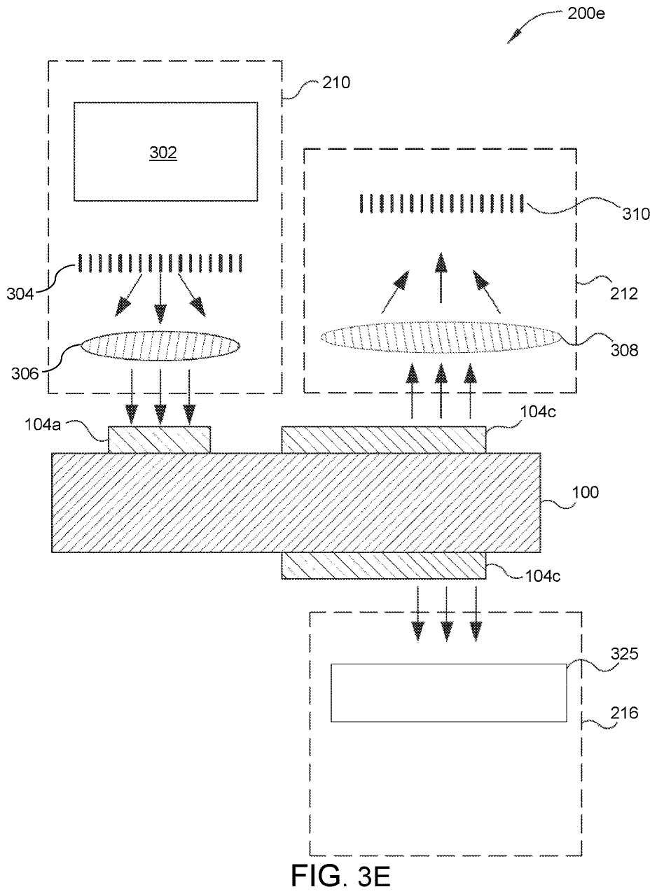

FIGS. 3A-3E are schematic illustrations of measurement systems 200a-200e. The measurement systems 200a-200e may be used for a method 400 of for determining an optical device MTF. The measurement system 200 includes the light engine 210, the transmission detector 216, and the reflection detector 212. The light engine 210 includes a light source 302, a reticle 304, and a first lens 306. The light engine 210 may further include at least one of a quarter-wave plate or linear polarizer. In some embodiments, which may be combined with other embodiments described herein, the light source 302 is configured to project red (about 610 nm-660 nm wavelength), green (about 510 nm-560 nm wavelength), and blue light (about 420 nm-470 nm wavelength). The reticle 304 may be a display.

In one embodiment, as shown in measurement system 200a of FIG. 3A, the transmission detector 216 includes a far field detector 310. The far field detector 310 is operable to detect outcoupled beams projected from the third grating 104c though the bottom side of the optical devices 100 to form a far field image. A second lens 308 is operable to focus the outcoupled image toward the far field detector 310. The far field detector 310 captures the far field image that potentially has some lost optical data due to a MTF failure of the optical device 100. The reflection detector 212 includes the near field detector 320. The near field detector 320 is operable to detect outcoupled beams projected from the third grating 104c through the top side of the optical device 100 to form a near field image. In some embodiments, the near field detector 320 is positioned less than about 3 mm from the third grating 104c of the optical device 100, such as less than about 1 mm from third grating 104c of the optical device 100. The near field detector 320 is positioned as close as possible to the third grating 104c of the optical device 100 in order minimize the amount of optical data lost due to MTF failure of the optical device 100. The near field image captured at the near field detector 320 and the far field image captured at the far field detector 310 are operable to be compared to determine if an MTF failure occurred.

In another embodiment, as shown in measurement system 200b of FIG. 3B, the reflection detector 212 includes the far field detector 310. The far field detector 310 is operable to detect outcoupled beams projected from the third grating 104c through the top side of the optical device 100 to form a far field image. A second lens 308 is operable to focus the outcoupled image toward the far field detector 310. The far field detector 310 captures a far field image that potentially has some lost optical data due to a MTF failure of the optical device 100. The transmission detector 216 includes the near field detector 320. The near field detector 320 is operable to detect outcoupled beams projected from the third grating 104c through the bottom side of the optical device 100 to form a near field image. In some embodiments, the near field detector 320 is positioned less than about 3 mm from the third grating 104c of the optical device 100, such as less than about 1 mm from third grating 104c of the optical device 100. The near field detector 320 is positioned as close as possible to the third grating 104c of the optical device 100 in order minimize the amount of optical data lost due to MTF failure of the optical device 100. The near field image captured at the near field detector 320 and the far field image captured at the far field detector 310 are operable to be compared to determine if an MTF failure occurred.

In another embodiment, as shown in measurement system 200c of FIG. 3C, the transmission detector 216 includes the far field detector 310. The far field detector 310 is operable to detect outcoupled beams projected from the third grating 104c through the bottom side of the optical device 100 to form a far field image. A second lens 308 is operable to focus the outcoupled image toward the far field detector 310. The far field detector 310 captures a far field image that potentially has some lost optical data due to a MTF failure of the optical device 100. The reflection detector 212 includes the near field detector 320. The near field detector 320 is operable to detect outcoupled beams projected from the third grating 104c through the top side of the optical device 100 to form a near field image. A third lens 322 is disposed between the third grating 104c. The third lens is positioned less than about 3 mm from the third grating 104c of the optical device 100, such as less than about 1 mm from third grating 104c of the optical device 100. The third lens 322 is positioned as close as possible to the third grating 104c of the optical device 100 in order minimize the amount of optical data lost due to MTF failure of the optical device 100. The third lens 322 is operable to focus the near field image toward the near field detector 320. The near field detector 320 is disposed from about 10 mm to about 50 mm from the third grating 104c. The near field image captured at the near field detector 320 and the far field image captured at the far field detector 310 are operable to be compared to determine if an MTF failure occurred.

In another embodiment, as shown in measurement system 200d of FIG. 3D, the transmission detector 216 includes the far field detector 310. The far field detector 310 is operable to detect outcoupled beams projected from the third grating 104c through the bottom side of the optical device 100 to form a far field image. A second lens 408 is operable to focus the outcoupled image toward the far field detector 310. The far field detector 310 captures an image that potentially has some lost optical data due to a MTF failure of the optical device 100. The reflection detector 212 is a wavefront sensor 325. The wavefront sensor 325 is operable to detect outcoupled beams projected from the third grating 104c through the top side of the optical device 100 to form a near field image. In some embodiments, the wavefront sensor 325 is positioned less than about 3 mm from the third grating 104c of the optical device 100, such as less than about 1 mm from third grating 104c of the optical device 100. The wavefront sensor 325 is positioned as close as possible to the third grating 104c of the optical device 100 in order minimize the amount of optical data lost due to MTF failure of the optical device 100. The near field image captured at the wavefront sensor 325 and the far field image captured at the far field detector 310 are operable to be compared to determine if an MTF failure occurred. The wavefront sensor 325 is further capable of measuring the phase (e.g., direction) of the light of the image.

In another embodiment, as shown in measurement system 200e of FIG. 3E, the reflection detector 212 includes the far field detector 310. The far field detector 310 is operable to detect outcoupled beams projected from the third grating 104c through the top side of the optical device 100 to form a far field image. A second lens 308 is operable to focus the outcoupled image toward the far field detector 310. The far field detector 310 captures a far field image that potentially has some lost optical data due to a MTF failure of the optical device 100. The transmission detector 216 is a wavefront sensor 325. The wavefront sensor 325 detects outcoupled beams projected from the third grating 104c through the bottom side of the optical device 100 to form a near field image. In some embodiments, the wavefront sensor 325 is positioned less than about 3 mm from the third grating 104c of the optical device 100, such as less than about 1 mm from third grating 104c of the optical device 100. The wavefront sensor 325 is positioned as close as possible to the third grating 104c of the optical device 100 in order minimize the amount of optical data lost due to MTF failure of the optical device 100. The near field image captured at the wavefront sensor 325 and the far field image captured at the far field detector 310 are operable to be compared to determine if an MTF failure occurred. The wavefront sensor 325 is further capable of measuring the phase (e.g., direction) of the light of the image.

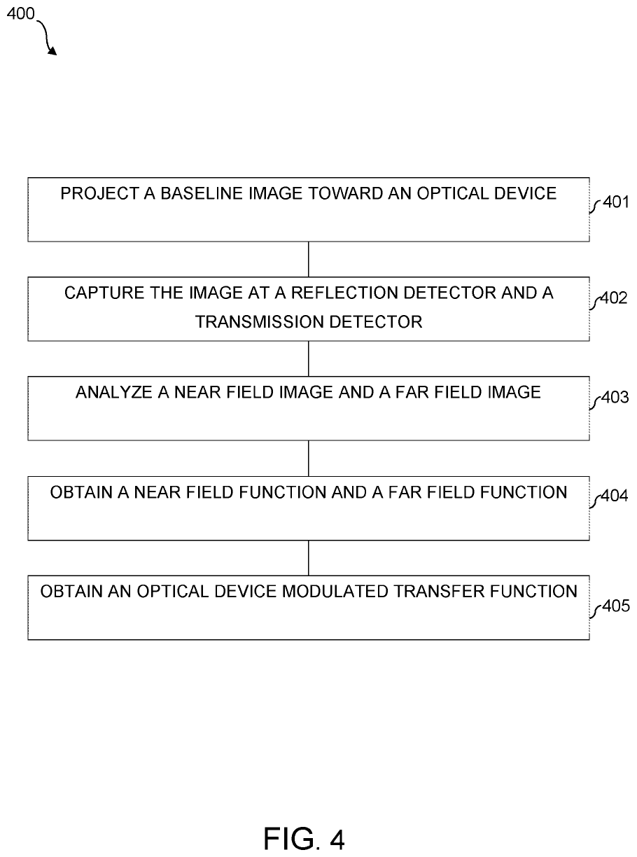

FIG. 4 is a flow diagram of a method 400 for determining an optical device MTF. The method 400 is operable to be performed in other measurement systems not described herein. The method 400 described herein includes illuminating the first grating 104a of an optical device 100 with the light engine 210 where the incoupled light undergoes TIR until it is outcoupled (e.g., reflected or transmitted) from the third grating 104c as images captured by the transmission detector 216 and reflection detector 212. The images may correspond to red, green, and blue channels from the light engine 210. The images are processed as described in the method 400 to extract the MTF of the optical device 100.

At operation 401, a baseline image is projected with the light engine 210 of the measurement system 200 toward an optical device 100. The baseline image is projected after the light source 302 projects red, green, or blue light through a reticle 304 to form a pattern. The baseline image is of the pattern. In some embodiments, which can be combined with other embodiments described, the light engine 210 is a high resolution image projector with a field of view (FOV) of about 10 degrees to about 120 degrees. The FOV of the light engine 210 is fixed or adjustable. The pattern is determined by the reticle 304. The reticle 304 may have one of a checkerboard pattern, line pair pattern, or a point matrix pattern. In some embodiments, which can be combined with other embodiments described, the reticle 304 is a high-resolution patterned mask. The pattern of the reticle 304 may be formed via e-beam, ion-beam, or photolithography. In other embodiments, which can be combined with other embodiments described, the light engine 210 is one of a LCOS, CLP, micro-light emitting diode (microLED), laser beam scanner, or organic light emitting diode (OLED) microdisplay.

The pattern is projected through the first lens 306 to a first grating 104a. The first lens 306 focuses the pattern toward the first grating 104a. The pattern undergoes TIR through the optical device 100 until the pattern is outcoupled from a third grating 104c. In some embodiments, which can be combined with other embodiments described herein, the optical device 100 may include a surface relief grating based waveguide combiner, a volume hologram based waveguide combiner, a birdbath waveguide combiner, a partial reflective mirror array combiner, or a free from optics combiner. The pattern is determined by the reticle 304. The reticle 304 may have one of a checkerboard pattern, a line pair pattern, or a point matrix pattern. In some embodiments, which can be combined with other embodiments described, the reticle 304 is a high-resolution patterned mask.

At operation 402, the image is captured at a reflection detector 212 and a transmission detector 216. The image is of the pattern formed by the reticle 304. In some embodiments, which can be combined with other embodiments described herein, the transmission detector 216 includes the far field detector 310, a near field detector 320, a wavefront sensor 325 or a combination thereof. In some embodiments, the reflection detector 212 includes the far field detector 310, the near field detector 320, the wavefront sensor 325, or a combination thereof. The near field detector 320 or the wavefront sensor 325 detect a near field image of the pattern formed by the reticle. The near field image is captured at or near the pupil pane of the third grating 104c, resulting in minimal optical data lost from any potential MTF failure within the optical device 100. The far field detector 310 detects a far field image at a distance approximately equal to a display distance of the optical device 100 (e.g., the distance at which the optical device would project the image for the user of the optical device to see). Any potential MTF failure would result in a distorted/degraded far field image.

At operation 403, the near field image and far field image are analyzed. In some embodiments, which can be combined with other embodiments described herein, the near field image and far field image is analyzed to locate a plurality of points on the near field image and far field image. Each of the plurality of points may correspond to a different FOV across the near field image and far field image. For example, each of the plurality of points may correspond to an edge of adjacent squares in a checkerboard pattern. The plurality of points are converted into a near field function and a far field function depending on the pattern formed. For example, the function may be a point spread function, a line spread function, or an edge spread function.

At operation 404, a near field function MTF of the near field function and a far field function MTF of the far field function are obtained. To properly obtain the function MTF corresponding to the baseline image, the light intensity variation across the image needs to be minimized. The light intensity variation across the image can be reduced by adjusting the exposure time of the image. The exposure time can be adjusted for each of the plurality of points of the near field function and the far field function.

At operation 405, the optical device MTF is obtained. By correlating the near field image and the far field image using the plurality of points and the function, a MTF performance can be measured and a failure can be detected. Further, the pupil function degradation along the propagation in the third grating 104c can be detected. Thus, the cause of the MTF failure can be detected. The optical device MTF obtained with the method 400 is less prone to be affected to imperfections of the light engine 210.

In summation, a method and apparatus for determining a MTF of an optical device is described herein. The apparatus includes a measurement system including a stage operable to retain an optical device or an optical device substrate having at least one optical device disposed thereon. A light engine is disposed above the stage. The light engine includes a light source operable to project a light to the optical device at a range of wavelengths. A reticle is operable to form a pattern from the light projected from the light source. A near field detector is operable to detect the light from the optical device or optical device substrate at the pupil plane of the optical device. A far field detector is operable to detect the light from the optical device of optical device substrate at a display distance of the optical device. The images of the light detected at the far field detector and near field detector are compared to determine the MTF of the optical device substrate or optical device. The cause of a MTF failure can further be detected by the measurement system.

While the foregoing is directed to embodiments of the present disclosure, other and further embodiments of the disclosure may be devised without departing from the basic scope thereof, and the scope thereof is determined by the claims that follow.

What is claimed is:

1. A measurement system, comprising:
a stage operable to retain an optical device or an optical device substrate having at least one optical device disposed thereon;
a light engine disposed above the stage, the light engine including:
a light source, the light source operable to project a light to the optical device at a range of wavelengths;
a reticle operable to form a pattern from the light projected from the light source; and
a first lens operable to collimate the light from the light source toward the optical device or optical device substrate;
a near field detector operable to detect the light from the optical device or optical device substrate; and
a far field detector operable to detect the light from the optical device of optical device substrate.

2. The measurement system of claim 1, wherein the near field detector is positioned at a top side of the optical device or optical device substrate and the far field detector is positioned at a bottom side of the optical device or optical device substrate.

3. The measurement system of claim 1, wherein the near field detector is positioned at a bottom side of the optical device or optical device substrate and the far field detector is positioned at a top side of the optical device or optical device substrate.

4. The measurement system of claim 1, wherein the near field detector is a wavefront sensor.

5. The measurement system of claim 1, wherein the stage is operable to move in an X-direction, a Y-direction, and a Z-direction.

6. The measurement system of claim 1, wherein the stage is transparent.

7. The measurement system of claim 1, further comprising an alignment camera operable to determine a position of the stage and the optical device or the optical device substrate.

8. A method, comprising:
projecting a baseline image of a pattern, the baseline image projected from a light engine of a measurement system, the measurement system having:
a stage disposed under the light engine, the stage operable to have one or more optical devices disposed thereon, wherein the light engine disposed above the stage projects the baseline image to the one or more optical devices; and
a near field detector operable to detect the light from the optical device; and
a far field detector operable to detect the light from the optical device;
capturing a near field image at the near field detector;
capturing a far field image at the far field detector;
analyzing the near field image and far field image to locate a first plurality of points on the near field image and far field image, the first plurality of points converted into a near field function and far field function;
obtaining a near field fast Fourier transform (FFT) of the near field function and far field FFT of the far field function; and
determining an optical device modulation transfer function (MTF) of the one or more optical devices, the optical device MTF determined by comparing the near field FFT to the far field FFT corresponding to the baseline image.

9. The method of claim 8, wherein the near field detector is positioned at a top side of the optical device or optical device substrate and the far field detector is positioned at a bottom side of the optical device or optical device substrate.

10. The method of claim 8, wherein the near field detector is positioned at a bottom side of the optical device or optical device substrate and the far field detector is positioned at a top side of the optical device or optical device substrate.

11. The method of claim 8, wherein the near field detector is a wavefront sensor.

12. The method of claim 8, wherein the baseline image is projected through a reticle to form the pattern.

13. The method of claim 8, wherein the light engine has a field of view of about 10 degrees to about 120 degrees.

14. The method of claim 8, wherein the stage is operable to move in an X-direction, a Y-direction, and a Z-direction.

15. A controller of a measurement system storing instructions that, when executed by a processor, causes the measurements system to measure optical properties of an optical device of optical device substrate disposed in a measurement system, wherein the optical properties of the optical device or optical device substrate comprises:
projecting a baseline image of a pattern, the baseline image projected from a light engine of a measurement system;
capturing a near field image at a near field detector of the measurement system;
capturing a far field image at a far field detector of the measurement system;
analyzing the near field image and far field image to locate a first plurality of points on the near field image and far field image, the first plurality of points converted into a near field function and far field function;
obtaining a near field fast Fourier transform (FFT) of the near field function and far field FFT of the far field function; and
determining an optical device modulation transfer function (MTF) of the one or more optical devices, the optical device MTF determined by comparing the near field FFT to the far field FFT corresponding to the baseline image.

16. The controller of claim 15, wherein the baseline image is projected through a reticle to form the pattern.

17. The controller of claim 15, wherein the near field detector is positioned at a top side of the optical device or optical device substrate and the far field detector is positioned at a bottom side of the optical device or optical device substrate.

18. The controller of claim 15, wherein the near field detector is positioned at a bottom side of the optical device or optical device substrate and the far field detector is positioned at a top side of the optical device or optical device substrate.

19. The controller of claim 15, wherein the near field detector is a wavefront sensor.

20. The controller of claim 15, wherein the light engine has a field of view of about 10 degrees to about 120 degrees.
